(19) United States
(12) Patent Application Publication
(10) Pub. No.: US 2008/0255486 A1
(43) Pub. Date: Oct. 16, 2008

(54) Shower massage device

(76) Inventor: Eric Ludlow, New City, NY (US)

Correspondence Address: Peter I. Bernstein;Scully, Scott, Murphy & Presser, P.C., Suite 300, 400 Garden City Plaza, Garden City, NY, 11530, US

(21) Appl. No.: 11/786,712

(22) Filed: Apr. 12, 2007

(51) Int. Cl. A61H 9/00

(52) U.S. Cl. 601/169; 601/160

(57) ABSTRACT

A shower massager device is provided for massaging a person's back in a shower. The shower massager device is designed to be portable, positionable for use by people of various heights and adjustable to various positions along the length of a person's back. The shower massager device includes a massager plate having a plurality of massaging protrusions arranged radially on an upper surface of the massager plate, and having a hole formed on an underside surface of the massager plate. In addition, a massager base for securely holding the massager plate to a shower surface is provided. A holding member is positioned on an underside of the massager base, and formed with a fastening member configured to be fixably received by the hole in the massager plate. A plurality of attaching members is affixed to a bottom surface of the massager base for removably securing the massager base to a shower surface, as well.

### I. FIELD OF THE INVENTION

This invention relates to shower massagers. More specifically, the invention relates to a shower massage device that is securable to a shower surface.

### I. BACKGROUND OF THE INVENTION

Massagers have been used by many people as a treatment for sore muscles—especially back muscles—and for a soothing and relaxing experience. Massages have been shown to provide medically beneficial results by increasing blood flow into the massaged area, and reducing knotted muscles. Conventional shower massagers use streams of pressurized water to provide the massaging effect. However, these shower massagers must be plumbed into the shower water supply, making conventional shower massagers difficult to install and not particularly portable.

### II. SUMMARY OF THE INVENTION

An object of the invention is to provide a shower massaging apparatus that is portable and easily adjusted to accommodate people of various heights, as well as the full length of a person's back.

The shower massager device of the present invention includes a massager plate having a plurality of massaging protrusions arranged radially on an upper surface of the massager plate, and having a hole formed on an underside surface of the massager plate. In addition, a massager base for securely holding the massager plate to a shower surface is provided.

Further, a holding member is positioned on an underside of the massager base, and formed with a fastening member configured to be fixably received by the hole in the massager plate. A plurality of attaching members is affixed to a bottom surface of the massager base for removably securing the massager base to a shower surface, as well.

### III. BRIEF DESCRIPTION OF THE DRAWINGS

These and other features, aspects, and advantages of the present invention will become better understood with regard to the following description, appended claims, and accompanying drawings wherein:

FIG. 1 illustrates an exploded side view of an embodiment of a shower massage device in accordance with the present invention;

FIG. 2 illustrates a bottom view of the shower massage device in accordance with the embodiment shown in FIG. 1.

### IV. DETAILED DESCRIPTION OF INVENTION

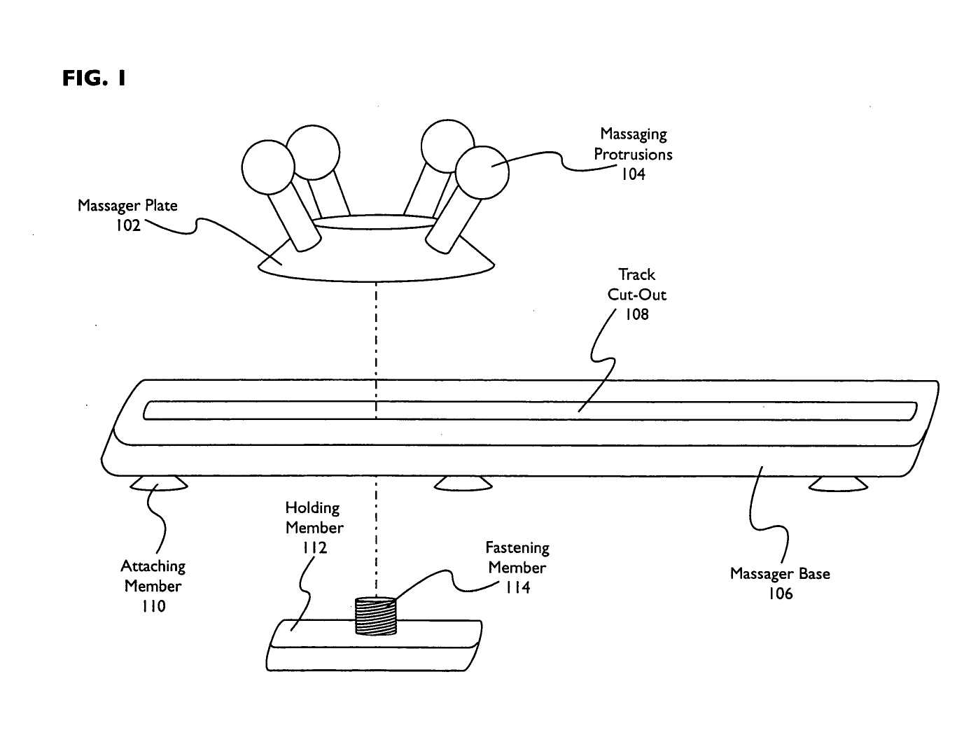

In accordance with the present invention, FIG. 1 illustrates components of a contemplated shower massage device. The present embodiment includes a massager plate 102. The massager plate 102 is disposed with a set of massaging protrusions 104. The massaging protrusions 104 are formed of a shaft terminating with an enlarged smooth rounded head at a distal end. At the underside of the massager plate 102, a threaded hole is formed at the center (not shown).

Alternatively, the device can be formed without the enlarged rounded heads at the distal end, rather the ends of the massaging protrusions can be smoothed and rounded so as to avoid edges, which may injure the user but otherwise are not enlarged. Also, the threaded hole can instead be a receiving end of any other type of coupler that when coupled to its other half forms a strong, disengageable connection.

In the embodiment shown in FIG. 1, four massaging protrusions 104 are shown arranged radially from a disk-shaped massager plate 102. However, any geometry can be used for the massager plate 102 and any number of massaging protrusions 104. Additionally, while the massaging protrusions 104 are shown as roughly equal lengths, in fact, the massaging protrusions 104 can be of varied lengths configured to better conform to the contours of a user's back. Moreover, the heads at the ends of the massaging protrusions 104 can be formed of a metal, hard plastic, nylon or acrylic, and can be left bare or covered with a cushioning surface.

The massaging protrusions can be permanently affixed to the massager plate 102 or can be removable. In the case in which the massaging protrusions 104 are removable, the massager plate 102 can be disposed with a plurality of holes greater than the number of massaging protrusions 104 and at various positions on the top surface of the massager plate 102. In this way, the user can customize the configuration of the massaging protrusions 104 to best suit the user's preference. Preferably, in this case, the massaging protrusions 104 are permanently affixed to the massager plate 102 and the height of the massaging protrusions 104 can be varied. Alternatively, the massaging protrusions 104 can be threaded at the proximal end and adapted to mate with threaded holes on the massager plate 102 so that the height the height of the massaging protrusions can be varied in this manner also or unitarily formed with the massager plate 102.

The massager plate is secured to a massager base 106 by way of a holding member 112. The holding member is formed with a fastening member 114 disposed on a top surface. The fastening member 114 is preferably a bolt-shaped protrusion having threads (or a complimentary coupler end for coupling to the receiving end of the coupler mentioned above), which are adapted to mate with the threaded hole formed on the underside of the massager plate 102. The fastening member 114 is dimensioned to adequately protrude from the bottom side of the massager base 106, where the holding member 112 is positioned, through a track cut-out 108 formed on the massager base 106 and running length-wise along an axis of the massager base 106. Enough of the fastening member 114 projects above the top surface of the massager base 106 to adequately fasten and secure the massager plate 102 to the holding member 112 and apply sufficient compressive force on the portion of the massager base 106 between the holding member 112 and massager plate 102 to prevent the massager plate 102 from sliding along the track cut-out 108.

The massager base 106 includes a set of attaching members 110, such as suction cups, on the bottom surface. These attaching members 110 are disposed and adapted to hold, non-permanently, the massager base securely to a shower wall surface, while allowing a user to remove the entire assembly when necessary.

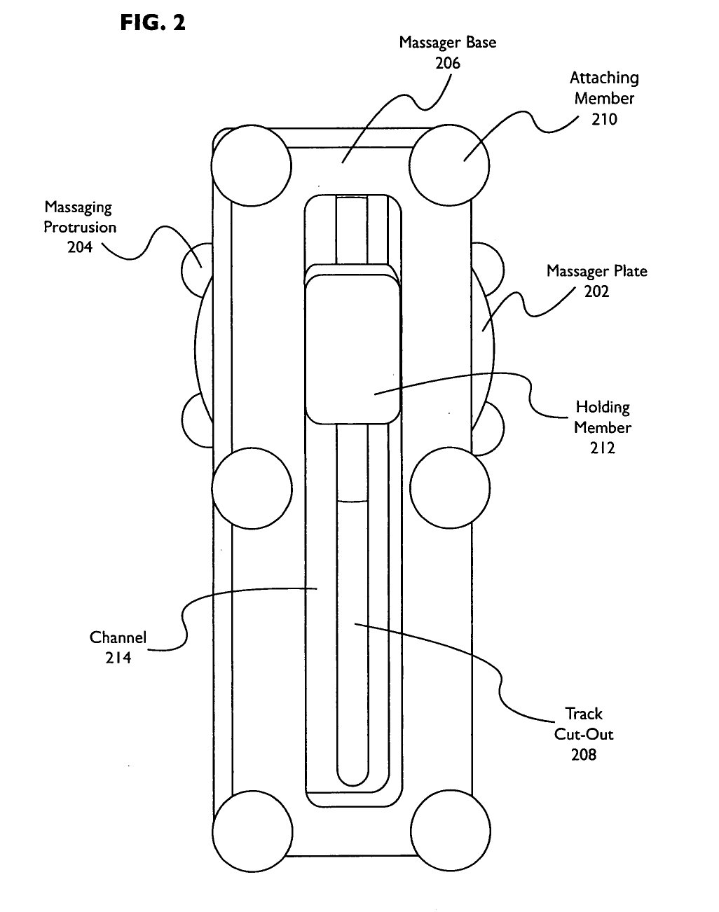

Referring now to FIG. 2, the massager of FIG. 1 is shown from a bottom view. The massager is shown in an assembled form. The massager plate 202 with the massaging protrusions 204 is firmly held in place on the massager base 206 with the holding member 212. The holding member is dimensioned to fit in a channel 214 formed in the massager base 206 such that a recess is formed along the path of the track cut-out 208. In this way, the bottom surface of the holding member 212 is flush, or nearly so, with the bottom surface of the massager base 206. The attaching members 210 are distributed at the bottom surface corners and along a central axis of the massager base 206.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. A shower massager device comprising:
a massager plate having a plurality of massaging protrusions arranged radially on an upper surface of said massager plate, said massager plate having a hole formed on an underside surface of said massager plate; and
a massager base for securely holding said massager plate to a shower surface.

2. The device as in claim 1, further comprising:
a holding member positioned on an underside of said massager base, said holding member formed with a fastening member configured to be fixably received by said hole; and
a plurality of attaching members affixed to a bottom surface of said massager base for removably securing said massager base to a shower surface.

3. The device as in claim 2, wherein said fastening member and said hole are correspondingly threaded.

4. The device as in claim 2, wherein said fastening member and said hole are formed as corresponding coupling means.

5. The device as in claim 2, wherein said attaching members are suction cups.

6. The device as in claim 1, wherein said massager base has a track along which said massager plate is adapted to slide.

7. The device as in claim 1, wherein said massaging protrusions having an enlarged rounded massaging head at a distal end.

8. The device as in claim 1, wherein said massaging protrusions are permanently held on said massager plate.

9. The device as in claim 1, wherein said massaging protrusions are removably held.

10. The device as in claim 1, wherein said massaging protrusions are of varied lengths and arranged on said massager plate according to length for conforming to contours of a user's back.

11. Method for providing a massage in a shower, said method comprising:
holding a plurality of massaging protrusions at a predefined arrangement;
affixing said plurality of massaging protrusions to a shower surface at a predetermined position relative to a user's back; and
moving a user's back against said massaging protrusions.

12. The method as in claim 11, wherein said massaging protrusions having an enlarged rounded massaging head at a distal end.

13. The method as in claim 11, further comprising:
sliding said plurality of massaging protrusions along a predefined path; and
anchoring said plurality of massaging protrusions at a user-selected location along said predefined path.

14. The method as in claim 11, wherein said massaging protrusions are of varied lengths and arranged on said massager plate according to length for conforming to contours of said user's back.

15. The method as in claim 11, wherein said massaging protrusions are permanently held.

16. The method as in claim 11, wherein said massaging protrusions are removably held.

17. A shower massager device comprising:
a massager plate having a plurality of massaging protrusions arranged radially on an upper surface of said massager plate, said massager plate having a hole formed on an underside surface of said massager plate;
a massager base for securely holding said massager plate to a shower surface;
a holding member positioned on an underside of said massager base, said holding member formed with a fastening member configured to be fixably received by said hole; and
a plurality of attaching members affixed to a bottom surface of said massager base for removably securing said massager base to a shower surface.

18. The device as in claim 17, wherein said fastening member and said hole are formed as corresponding one of threaded portions or coupling means.

19. The device as in claim 17, wherein said attaching members are suction cups.

20. The device as in claim 17, wherein said massaging protrusions having an enlarged rounded massaging head at a distal end.

21. The device as in claim 17, wherein said massaging protrusions are permanently held on said massager plate.

22. The device as in claim 17, wherein said massaging protrusions are removably held on said massager plate.

23. The device as in claim 17, wherein said massaging protrusions are of varied lengths and arranged on said massager plate according to length for conforming to contours of a user's back.
